(19) United States
(12) Patent Application Publication
(10) Pub. No.: US 2016/0048896 A1
(43) Pub. Date: Feb. 18, 2016

(54) CUSTOM FLAT CABLE CONFIGURATOR

(71) Applicants: HOWARD LIND, PORTER RANCE, CA (US); JOHN PALAHNUK, Valencia, CA (US)

(72) Inventors: HOWARD LIND, PORTER RANCE, CA (US); JOHN PALAHNUK, Valencia, CA (US)

(21) Appl. No.: 14/460,950

(22) Filed: Aug. 15, 2014

(51) Int. Cl. G06Q 30/06

(52) U.S. Cl. CPC G06Q 30/0621

(57) ABSTRACT

The embodiments disclose an apparatus including a custom flat cable configurator program to allow a user to design a custom flat cable using cable elements, at least one drag and drop flat cable element, wherein a user selects at least one cable element, a digital code program to automatically create a concurrent cable assembly drawing, a listing of selected cable elements and a cable price from user drag and drop selected cable elements, and a user interface wherein the user submits a final custom flat cable configurator program cable assembly and the user automatically is sent an email with a final cable assembly drawing, a no-obligation price, a final listing of selected cable elements and final custom flat cable purchase instructions.

### BACKGROUND

Multiple cable element groupings may take a great deal of time and effort to design. Cable users who order cable groupings and most cable manufacturers go back and forth to arrive at an acceptable design during which the cost of manufacturing each design must be calculated.

### BRIEF DESCRIPTION OF THE DRAWINGS

FIG. 1 shows a block diagram of an overview of a custom flat cable configurator of one embodiment.

FIG. 2 shows a block diagram of an overview flow chart of a user drag and drop webpage interface of one embodiment.

FIG. 3 shows a block diagram of an overview flow chart of cable assembly area feature of one embodiment.

FIG. 4 shows for illustrative purposes only an example of custom flat cable configurator program application of one embodiment.

FIG. 5 shows for illustrative purposes only an example of EZ-strip flat cable element of one embodiment.

FIG. 6 shows for illustrative purposes only an example of a life calculator software program of one embodiment.

FIG. 7 shows for illustrative purposes only an example of flexible flat cable configurator website features of one embodiment.

FIG. 8 shows for illustrative purposes only an example of first drag and drop function of one embodiment.

FIG. 9 shows for illustrative purposes only an example of incorporating cable elements of one embodiment.

FIG. 10 shows for illustrative purposes only an example of automatic cable dimensioning function of one embodiment.

FIG. 11 shows for illustrative purposes only an example of sectionalizing cable elements of one embodiment.

FIG. 12 shows for illustrative purposes only an example of deleting cable elements of one embodiment.

FIG. 13 shows for illustrative purposes only an example of a user completing a cable assembly design of one embodiment.

FIG. 14 shows for illustrative purposes only an example of a user final cable assembly submittal of one embodiment.

FIG. 15 shows for illustrative purposes only an example of a power cable element group of one embodiment.

FIG. 16 shows for illustrative purposes only an example of a signal cable element group of one embodiment.

FIG. 17 shows for illustrative purposes only an example of video and tubing cable element groups of one embodiment.

FIG. 18 shows for illustrative purposes only an example of modules and jacket elements cable element groups of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a custom flat cable configurator is described for illustrative purposes and the underlying system can apply to any number and multiple types cables. In one embodiment of the present invention, the custom flat cable configurator can be configured using multiple cable element groups. The custom flat cable configurator can be configured to include computer programmable code and can be configured to include a digital mobile device programmable application using the present invention.

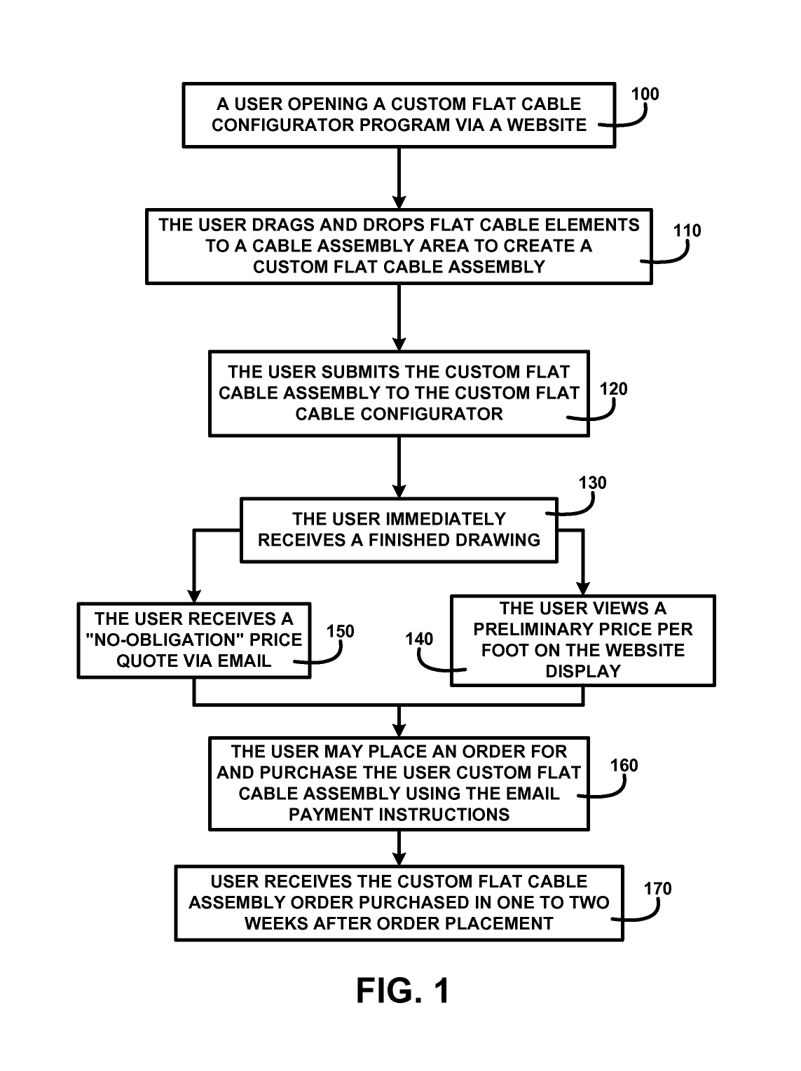

FIG. 1 shows a block diagram of an overview of a custom flat cable configurator of one embodiment. FIG. 1 shows a user opening a custom flat cable configurator program via a website 100. The user drags and drops flat cable elements to a cable assembly area to create a custom flat cable assembly 110. The user submits the custom flat cable assembly to the custom flat cable configurator 120. After submittal the user immediately receives a finished drawing 130 and the user receives a “no-obligation” price quote via email 140. The user views a preliminary price per foot on the website display 150. The user may place an order for and purchase the user custom flat cable assembly using the email payment instructions 160. After placing an order the user receives the custom flat cable assembly order purchased in one to two weeks after order placement 170.

### Detailed Description:

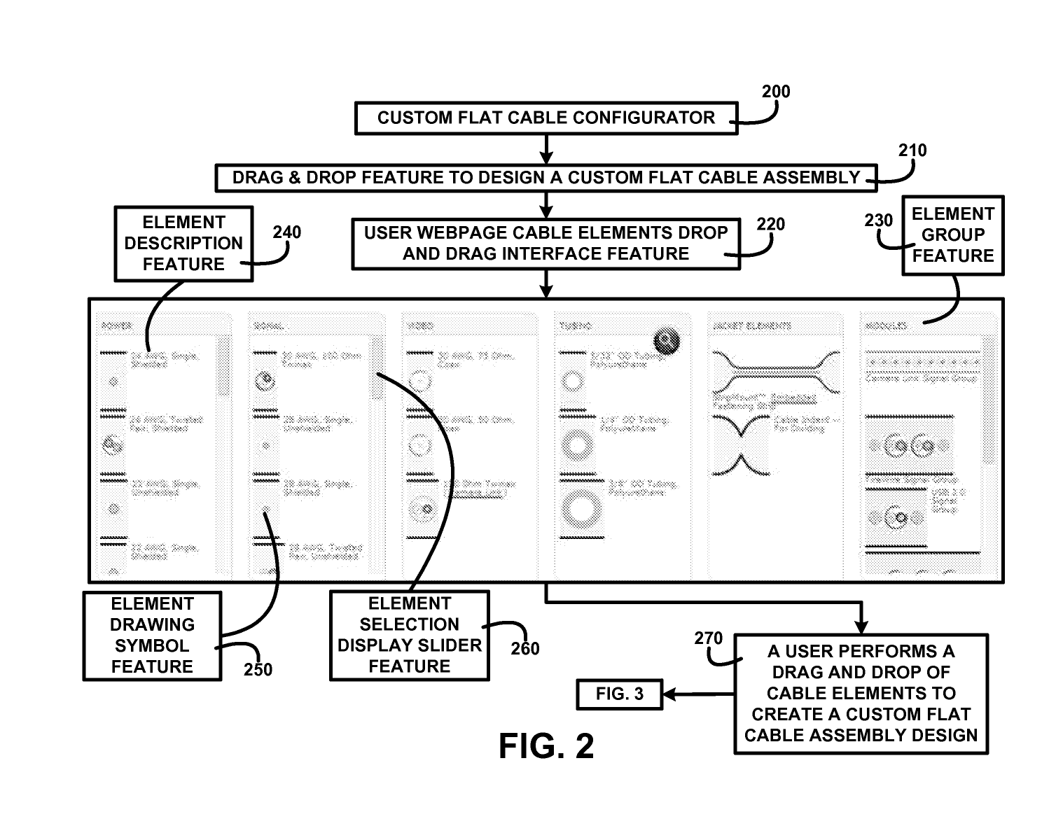

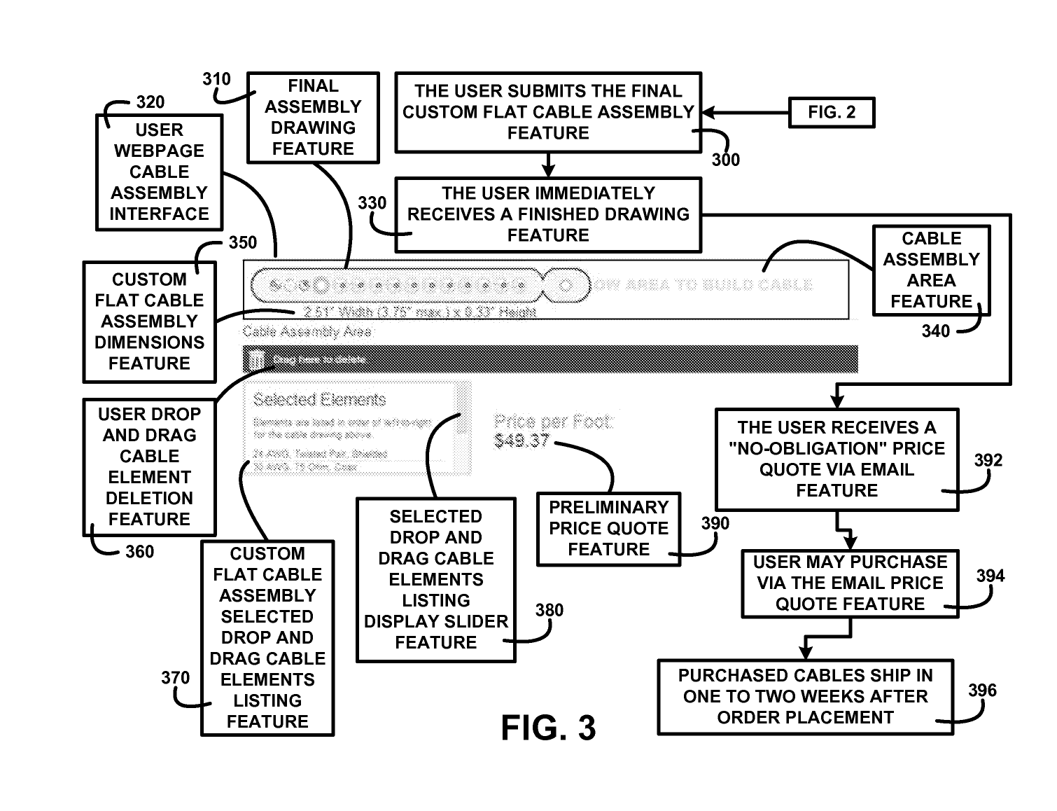

FIG. 2 shows a block diagram of an overview flow chart of a user drag and drop webpage interface of one embodiment. FIG. 2 shows the custom flat cable configurator 200 including a drag & drop feature to design a custom flat cable assembly 210. A user webpage cable elements drop and drag interface feature 220 used by the user where a user performs a drag and drop of cable elements to create a custom flat cable assembly design 230. The user may select from a element group feature 240 multiple cable elements from an element description feature 250 and an element drawing symbol feature 260. The selections are displayed using an element selection display slider feature 270. The features and procedures continue in FIG. 3 of one embodiment.

### Cable Assembly Area Feature:

FIG. 3 shows a block diagram of an overview flow chart of cable assembly area feature of one embodiment. FIG. 3 shows where the user submits the final custom flat cable assembly feature 300. Upon submittal the user immediately receives a finished drawing feature 330 and the user receives a “no-obligation” price quote via email feature 392. The user may purchase via the email price quote feature 394 the final custom designed flat cable assembly. The user purchased cables ship in one to two weeks after order placement 396 by the user. A final assembly drawing feature 310 is shown in a user webpage cable assembly interface 320 in a cable assembly area feature 340 and that automatically updates as the user make selections. The webpage shows a custom flat cable assembly dimensions feature 350 to inform the user of the size of the final custom flat cable assembly and that automatically updates as the user make selections. The user may change previously selected elements using a user drop and drag cable element deletion feature 360. During the selection process a user may view a custom flat cable assembly selected drop and drag cable elements listing feature 370 to check which elements they have selected. The cable elements listing feature includes a selected drop and drag cable elements listing display slider feature 380 allowing the user to scroll up and down the listing. The webpage displays a preliminary price quote feature 390 that automatically updates as the user make selections.

### Custom Flat Cable Configurator Program Application:

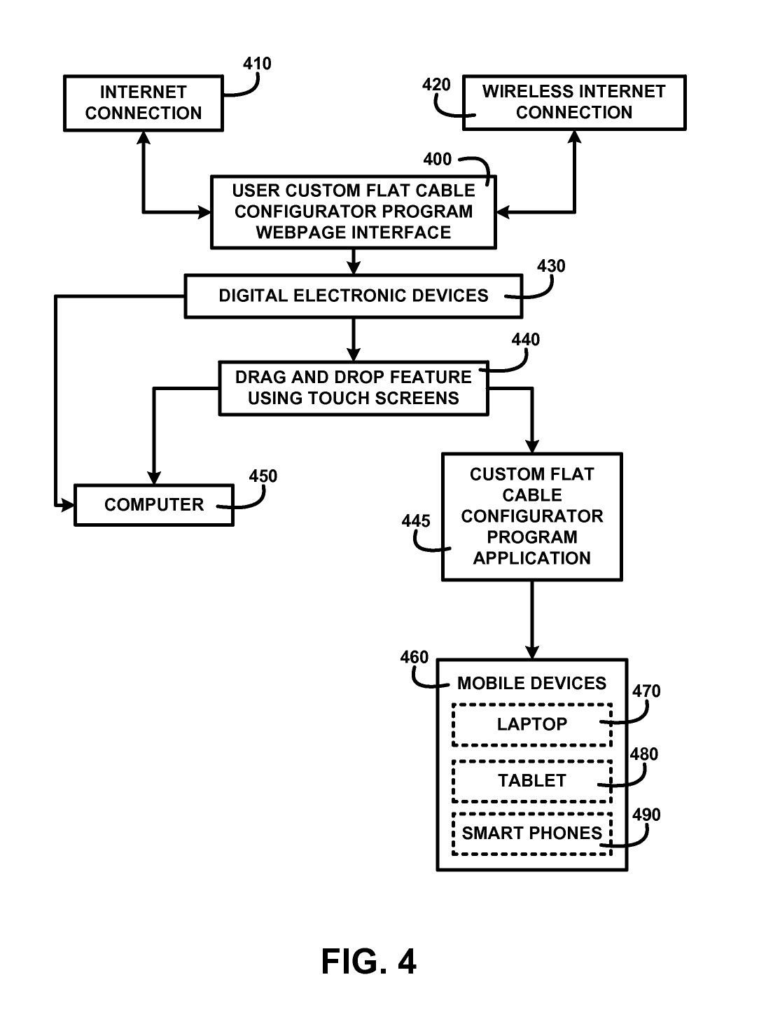

FIG. 4 shows for illustrative purposes only an example of custom flat cable configurator program application of one embodiment. FIG. 4 shows a user custom flat cable configurator program webpage interface 400. The custom flat cable configurator program webpage may be accessed using an internet connection 410 and a wireless internet connection 420 using digital electronic devices 430. The custom flat cable configurator program webpage interface includes a drag and drop feature using touch screens 440. A user may access the custom flat cable configurator program webpage using digital electronic devices 430 including a computer 450 and mobile devices 460. A custom flat cable configurator program application 445 may be used with mobile devices 460 including a laptop 470, a tablet 480 and smart phones 490 of one embodiment.

### EZ-Strip Flat Cable Element:

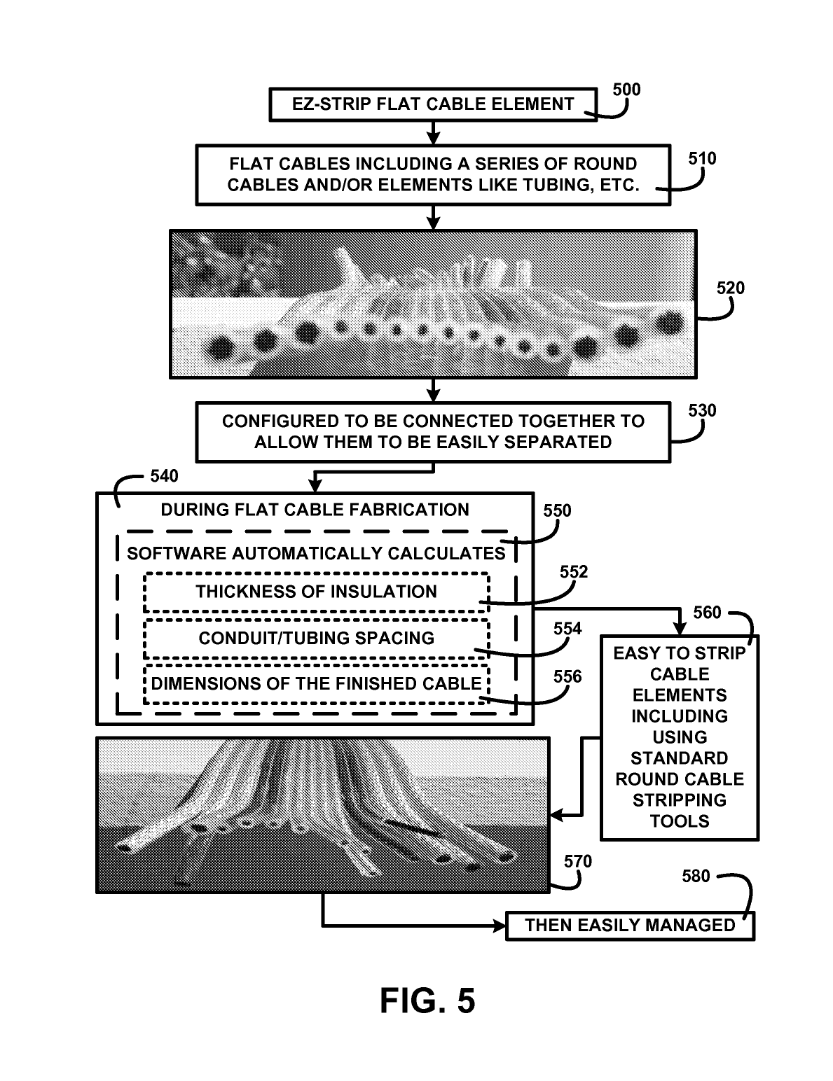

FIG. 5 shows for illustrative purposes only an example of EZ-strip flat cable element of one embodiment. FIG. 5 shows an EZ-strip flat cable element 500 that is incorporates into flat cables including a series of round cables and/or elements like tubing, etc. 510. An EZ-strip flat cable assembly 520 may be configured to be connected together to allow them to be easily separated 530. During flat cable fabrication 540, software automatically calculates 550 a thickness of insulation 552, conduit/tubing spacing 554 and dimensions of the finished cable 556. The EZ-strip flat cable element creates easy to strip cable elements including using standard round cable stripping tools 560. The EZ-strip flat cable assembly with separated cable elements 570 is then easily managed 580 of one embodiment.

### Life Calculator Software Program:

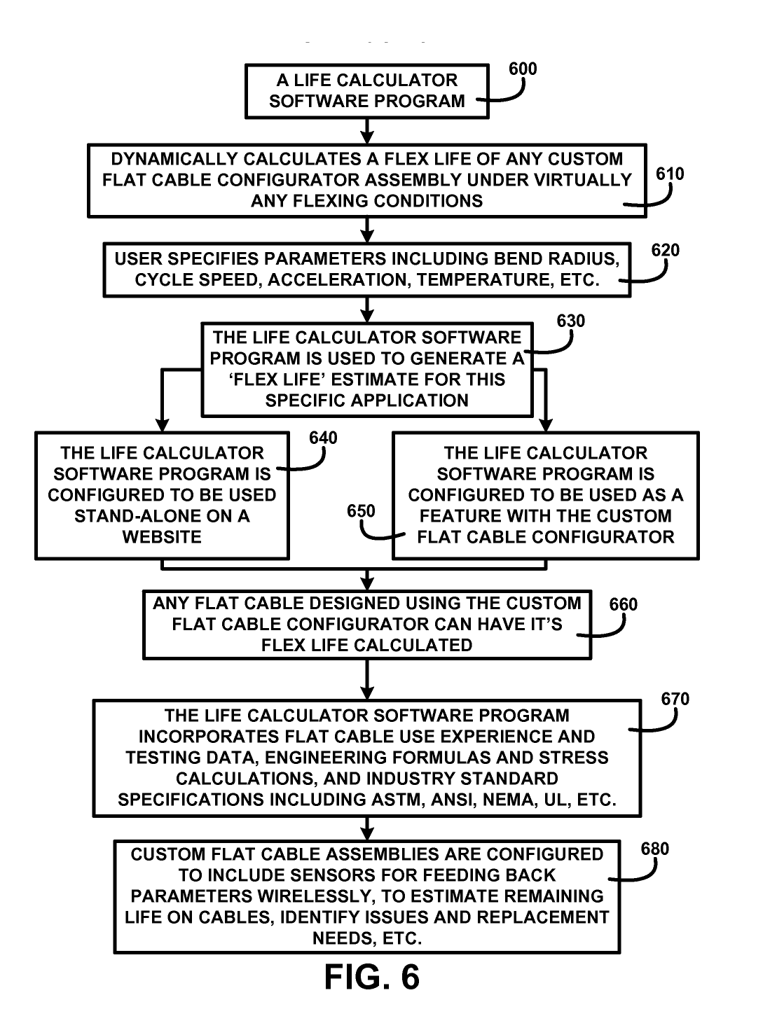

FIG. 6 shows for illustrative purposes only an example of a life calculator software program of one embodiment. FIG. 6 shows a life calculator software program 600 dynamically calculates a flex life of any custom flat cable configurator assembly under virtually any flexing conditions 610. The user specifies parameters including bend radius, cycle speed, acceleration, temperature, etc. 620. The life calculator software program is used to generate a ‘flex life’ estimate for this specific application 630. The life calculator software program is configured to be used stand-alone on a website 640. The life calculator software program is configured to be used as a feature with the custom flat cable configurator 650 where any flat cable designed using the custom flat cable configurator can have it's flex life calculated 660. The life calculator software program incorporates flat cable use experience and testing data, engineering formulas and stress calculations, and industry standard specifications including astm, ansi, nema, ul, etc. 670. Custom flat cable assemblies are configured to include sensors for feeding back parameters wirelessly, to estimate remaining life on cables, identify issues and replacement needs, etc. 680

### Flexible Flat Cable Configurator Website Features:

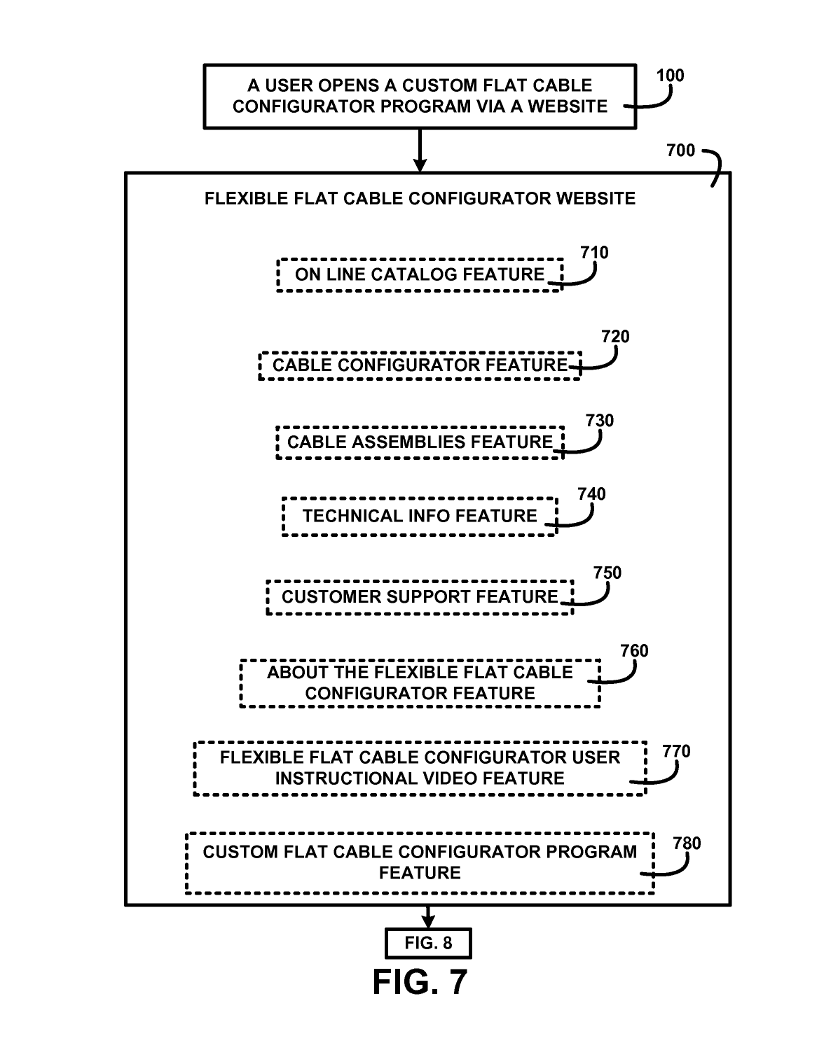

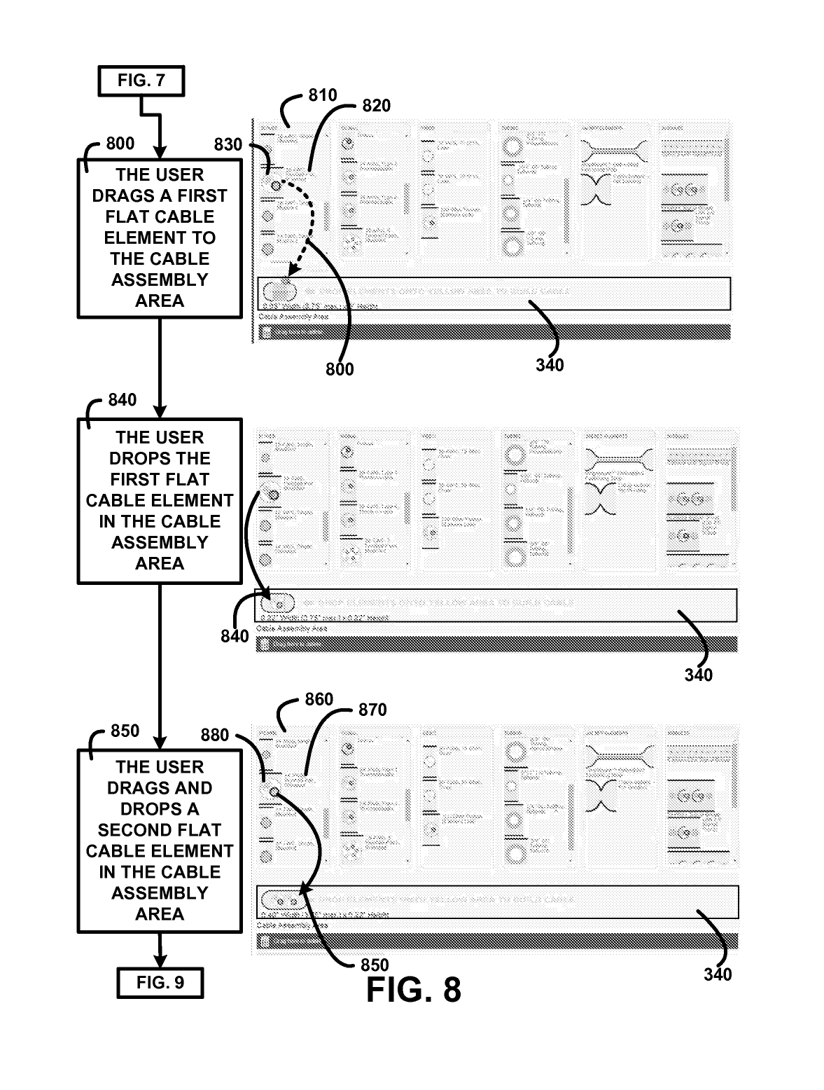

FIG. 7 shows for illustrative purposes only an example of flexible flat cable configurator website features of one embodiment. FIG. 7 shows a user opening a custom flat cable configurator program via a website 100. The flexible flat cable configurator website 700 includes an on line catalog feature 710, a cable configurator feature 720, a cable assemblies feature 730, a technical info feature 740, a customer support feature 750, an about the flexible flat cable configurator feature 760, a flexible flat cable configurator user instructional video feature 770, and a custom flat cable configurator program feature 780 of one embodiment. The flexible flat cable configurator website features user interface interactive procedures are described in FIG. 8.

### First Drag and Drop Function:

FIG. 8 shows for illustrative purposes only an example of first drag and drop function of one embodiment. FIG. 8 shows a continuation from FIG. 7 including a screen shot of the cable configurator webpage where the user drags a first flat cable element to the cable assembly area 800. The user selects from a first element group 810 a first element description 820 and a first element drawing symbol 830. The user drops the first flat cable element in the cable assembly area 840 as shown in the cable assembly area feature 340. The user drags and drops a second flat cable element in the cable assembly area 850 from a second element group 860 where the user selects a second element description 870 and a second element drawing symbol 880 of one embodiment.

### Incorporating Cable Elements:

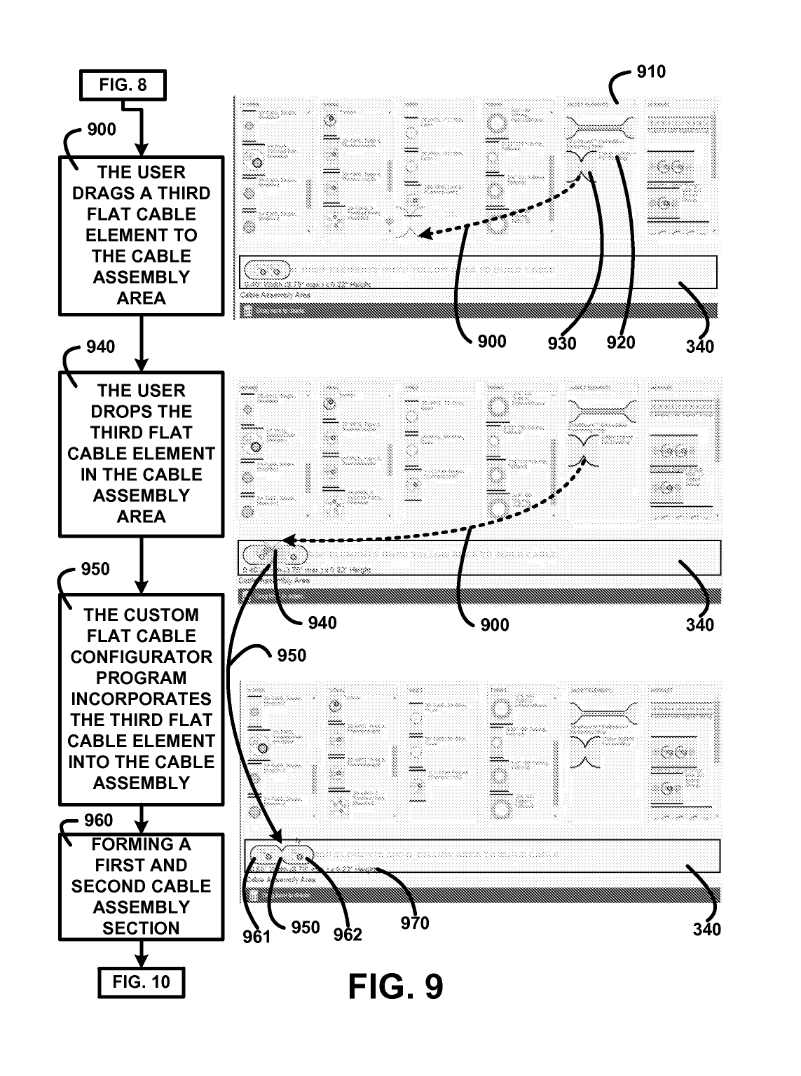

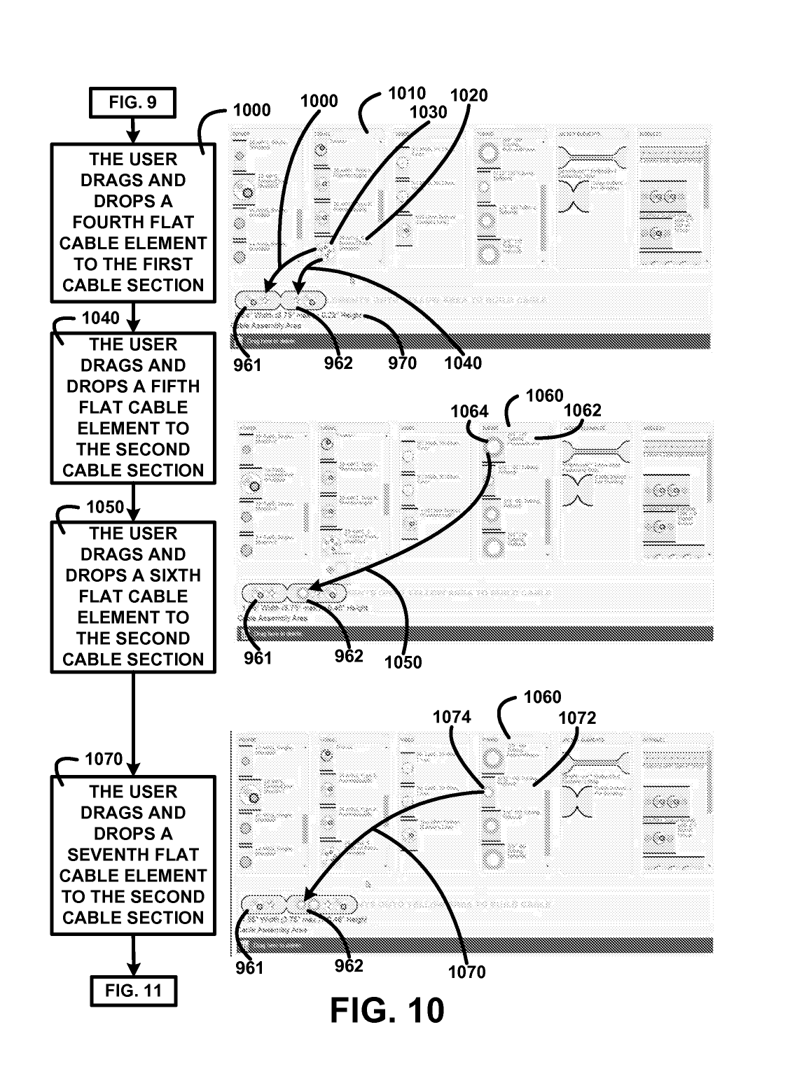

FIG. 9 shows for illustrative purposes only an example of incorporating cable elements of one embodiment. FIG. 9 shows a continuation from FIG. 8 where the user drags a third flat cable element to the cable assembly area 900 from a third element group 910. The user drops the third flat cable element in the cable assembly area 940 where a third element description 920 is added to the listing and a third element drawing symbol 930 is added using the cable assembly area feature 340 as seen in the drawing. The custom flat cable configurator program incorporates the third flat cable element into the cable assembly 950 forming a first and second cable assembly section 960. A first cable section 961 and a second cable section 962 is shown in the drawing. The cable configurator program automatically updates the custom flat cable assembly dimensions feature 970 of one embodiment. The processing continues in FIG. 10.

### Automatic Cable Dimensioning Function:

FIG. 10 shows for illustrative purposes only an example of automatic cable dimensioning function of one embodiment. FIG. 10 shows a continuation from FIG. 9 where the user drags and drops a fourth flat cable element to the first cable section 1000 as seen in the webpage display of a first cable section 961 and a second cable section 962. The user drags and drops a fifth flat cable element to the second cable section 1040. The cable configurator program automatically custom flat cable assembly dimensions feature 970. The user drags and drops a sixth flat cable element to the second cable section 1050 by selecting from a sixth element group 1060 and selects a sixth element description 1062 and a sixth element drawing symbol 1064. The user drags and drops a seventh flat cable element to the second cable section 1070 from a sixth element group 1060 and selects a seventh element description 1072 and a seventh element drawing symbol 1074 of one embodiment.

### Sectionalizing Cable Elements:

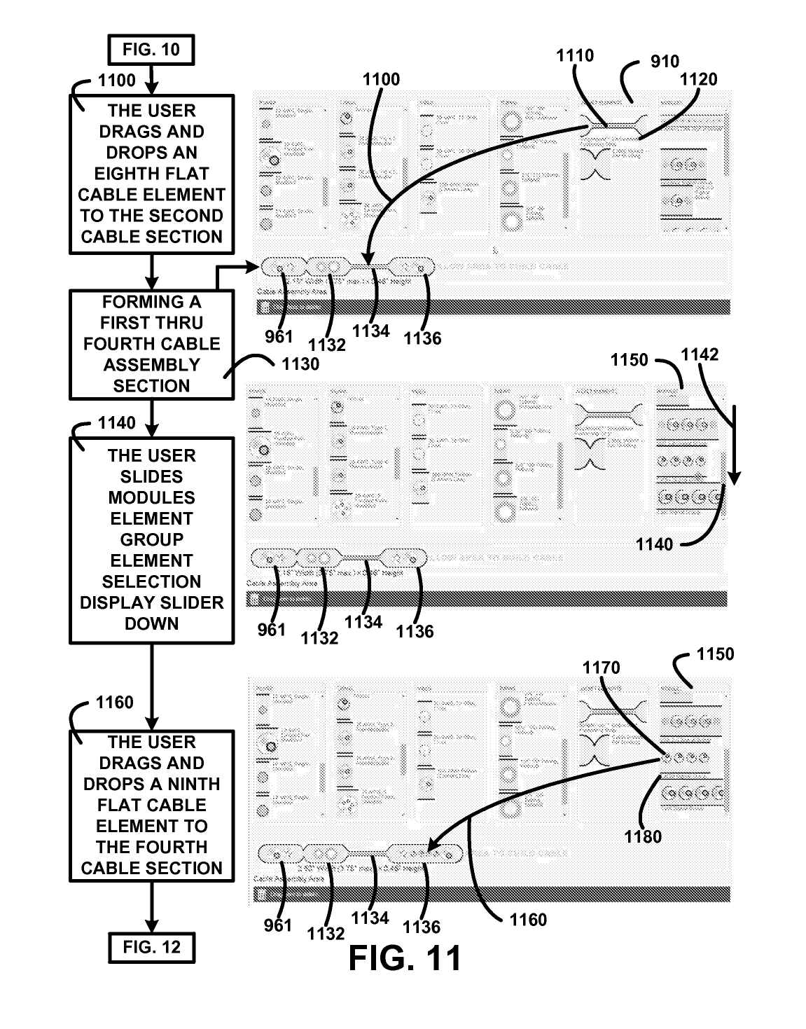

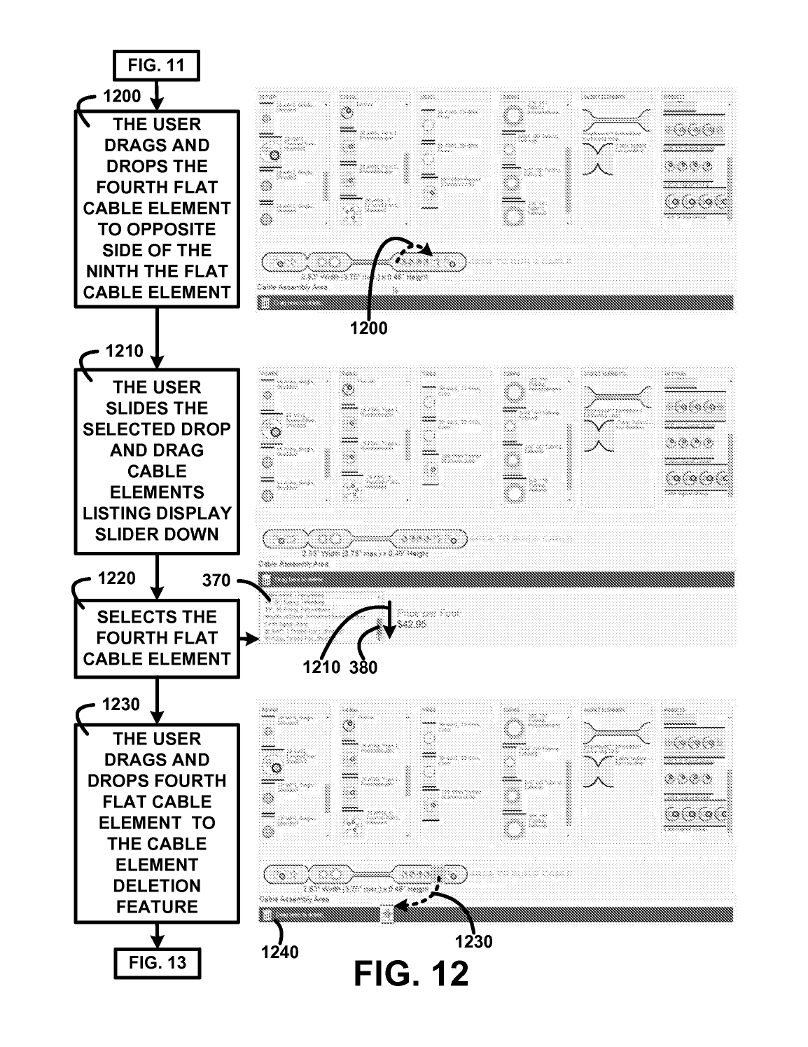

FIG. 11 shows for illustrative purposes only an example of sectionalizing cable elements of one embodiment. FIG. 11 shows a continuation from FIG. 10 where the user drags and drops an eighth flat cable element to the second cable section 1100. The user selects from a third element group 910 and selects a eighth element description 1120 and a eighth element drawing symbol 1110. The eighth flat cable element incorporation forms a first cable section 961, a second cable section 1132, a third cable section 1134, and a fourth cable section 1136. The user slides modules element group element selection display slider down 1140 of a seventh element selection display slider 1142 to review the cable elements in a seventh element group 1150. The user drags and drops a ninth flat cable element to the fourth cable section 1160. A ninth element description 1180 is added to the selected cable element listing and a ninth element drawing symbol 1170 is incorporated into the drawing of one embodiment. The process continues in FIG. 12.

### Deleting Cable Elements:

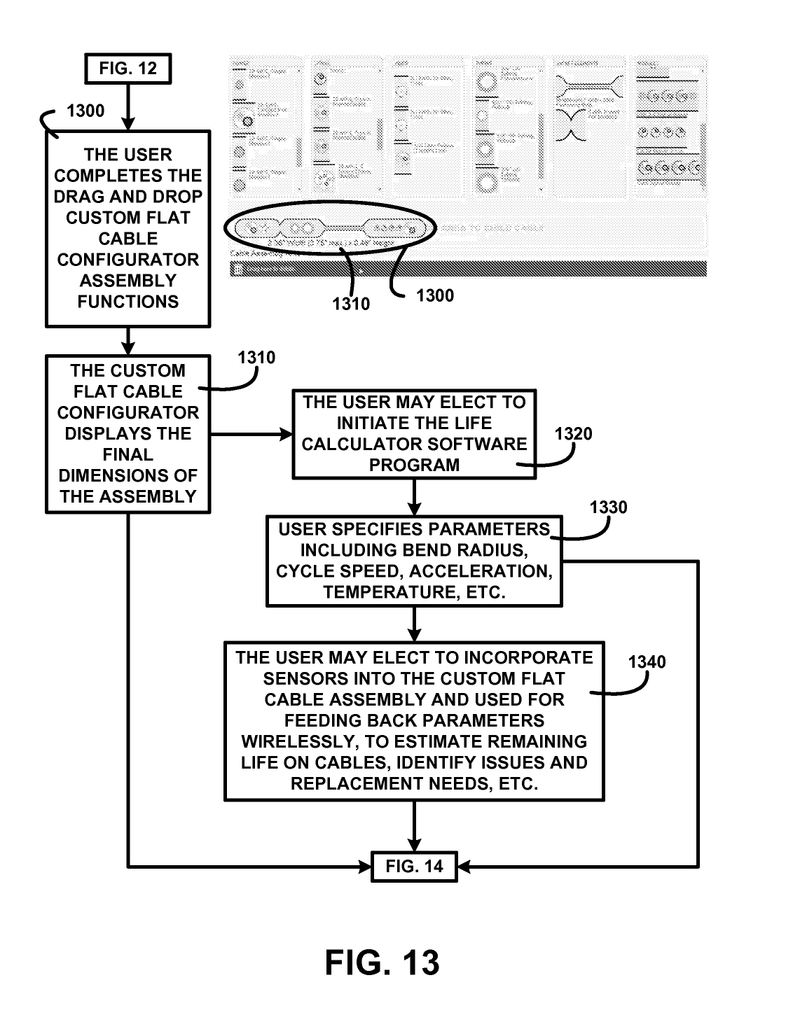

FIG. 12 shows for illustrative purposes only an example of deleting cable elements of one embodiment. FIG. 12 shows a continuation from FIG. 11 where the user drags and drops the fourth flat cable element to opposite side of the ninth the flat cable element 1200. The user slides the selected drop and drag cable elements listing display slider down 1210 and selects the fourth flat cable element 1220 from the selected drop and drag cable elements listing 370. Identifying the fourth flat cable element using the selected drop and drag cable elements listing display slider 380 the user drags and drops fourth flat cable element to the cable element deletion feature 1230. A drag here to delete feature 1240 removes the fourth flat cable element from the listing and drawing of one embodiment. The process continues in FIG. 13.

### A User Completing a Cable Assembly Design:

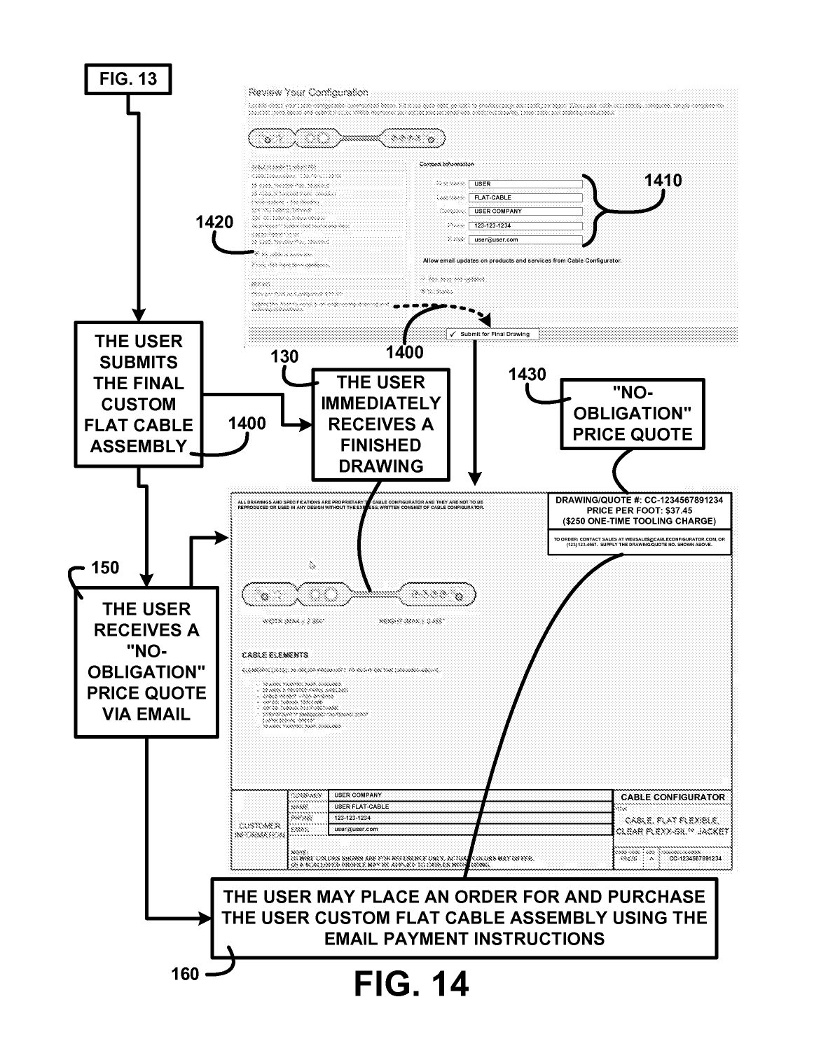

FIG. 13 shows for illustrative purposes only an example of a user completing a cable assembly design of one embodiment. A continuation from FIG. 12 is shown in FIG. 13 showing where the user completes the drag and drop custom flat cable configurator assembly functions 1300. The custom flat cable configurator displays the final dimensions of the assembly 1310. The user may elect to initiate the life calculator software program 1320 where the user specifies parameters including bend radius, cycle speed, acceleration, temperature, etc. 1330. The software will generate a ‘flex life’ estimate for this specific application. The user may elect to incorporate sensors into the custom flat cable assembly and used for feeding back parameters wirelessly, to estimate remaining life on cables, identify issues and replacement needs, etc. 1340 of one embodiment. The process continues in FIG. 14.

### A User Final Cable Assembly Submittal:

FIG. 14 shows for illustrative purposes only an example of a user final cable assembly submittal of one embodiment. FIG. 14 continues from FIG. 13 and shows the user submits the final custom flat cable assembly 1400. The user enters contact information 1410. The user may view the final custom flat cable assembly selected elements listing 1420. The user immediately receives a finished drawing 130. The user receives a “no-obligation” price quote via email 150 and a no-obligation price quote 1430. The user may place an order for and purchase the user custom flat cable assembly using the email payment instructions 160 of one embodiment.

### A Power Cable Element Group:

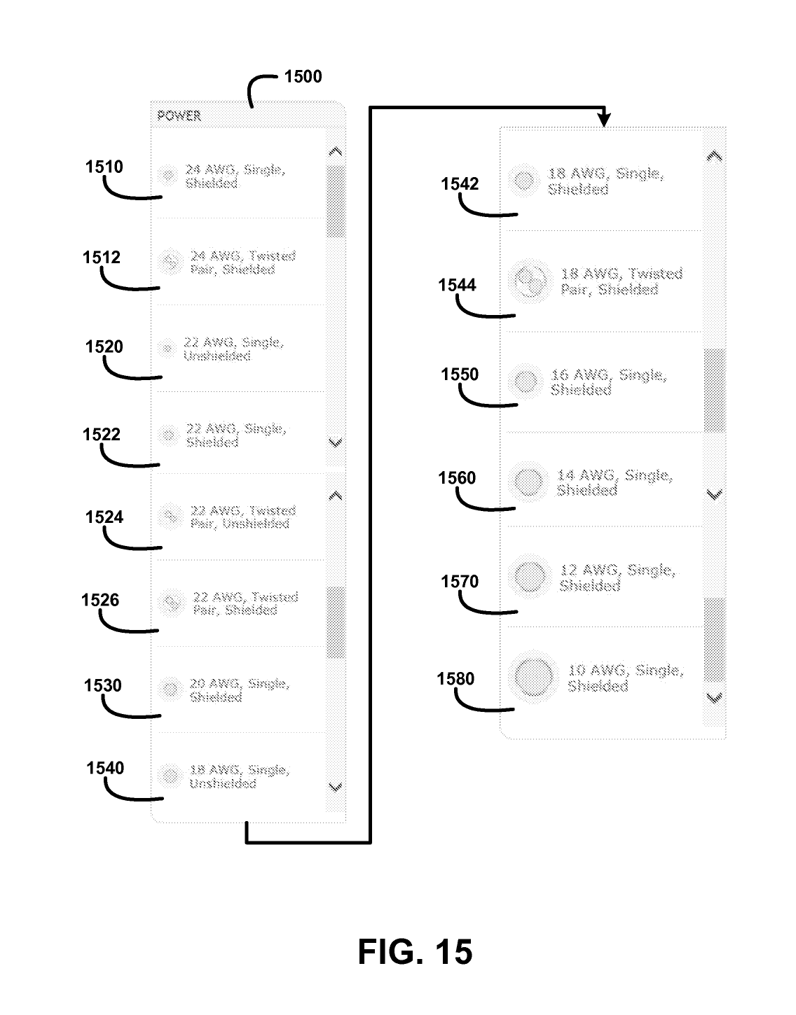

FIG. 15 shows for illustrative purposes only an example of a power cable element group of one embodiment. FIG. 15 shows an example of POWER 1500 a cable element group. POWER 1500 cable element group includes 24 AWG, Single, Shielded 1510, 24 AWG, Twisted Pair, Shielded 1512, 22 AWG, Single, Unshielded 1520, 22 AWG, Single, Shielded 1522, 22 AWG, Twisted Pair, Unshielded 1524, 22 AWG, Twisted Pair, Shielded 1526, 20 AWG, Single, Shielded 1530, 18 AWG, Single, Unshielded 1540, 18 AWG, Single, Shielded 1542, 18 AWG, Twisted Pair, Shielded 1544, 16 AWG, Single, Shielded 1550, 14 AWG, Single, Shielded 1560, 12 AWG, Single, Shielded 1570, and 10 AWG, Single, Shielded 1580 of one embodiment.

### A Signal Cable Element Group:

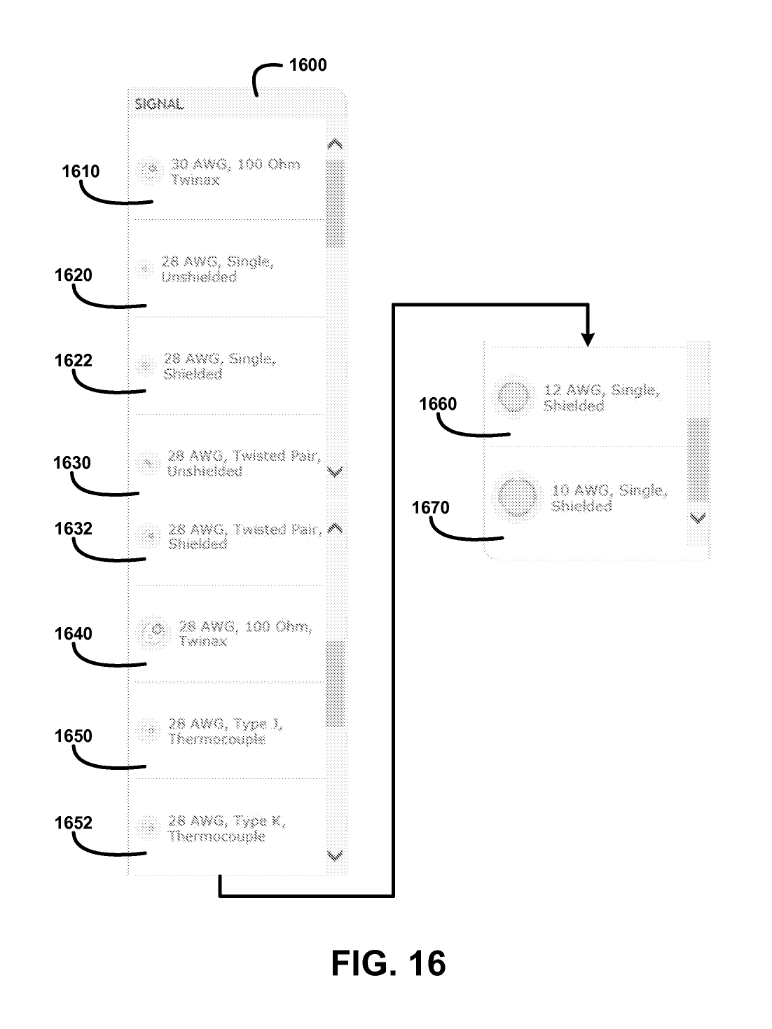

FIG. 16 shows for illustrative purposes only an example of a signal cable element group of one embodiment. FIG. 16 shows an example of SIGNAL 1600 a cable element group. SIGNAL 1600 cable element group includes 30 AWG, 100 Ohm Twinax 1610, 28 AWG, Single, Unshielded 1620, 28 AWG, Single, Shielded 1622, 28 AWG, Twisted Pair, Unshielded 1630, 28 AWG, Twisted Pair, Shielded 1632, 28 AWG, 100 Ohm, Twinax 1640, 28 AWG, Type J, Thermocouple 1650, 28 AWG, Type K, Thermocouple 1652, 28 AWG, 5 Twisted Pairs, Shielded 1654, 26 AWG, Single, Shielded 1660, 26 AWG, Twisted Pair, Shielded 1662, 26 AWG, Twisted Tri, Shielded 1664, and 24 AWG, 100 Ohm, Twinax 1670 of one embodiment.

### Video and Tubing Cable Element Groups:

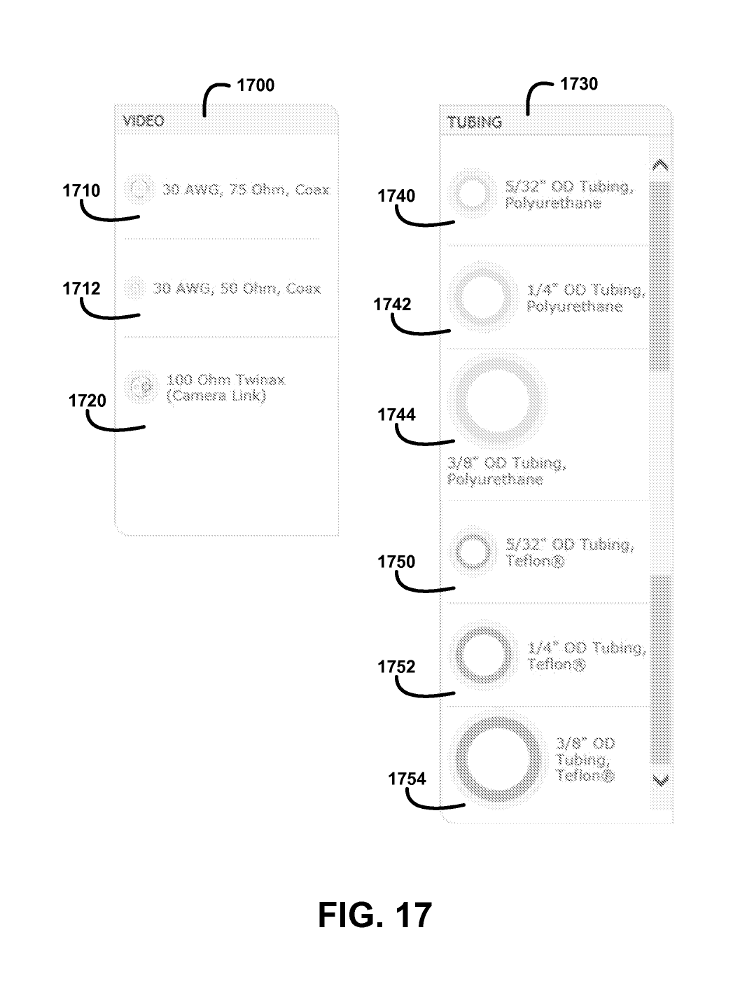

FIG. 17 shows for illustrative purposes only an example of video and tubing cable element groups of one embodiment. FIG. 17 shows an example of VIDEO 1700 a cable element group. VIDEO 1700 cable element group includes 30 AWG, 75 Ohm, Coax 1710, 30 AWG, 50 Ohm, Coax 1712, and 100 Ohm Twinax (Camera Link) 1720 of one embodiment.

FIG. 17 shows an example of TUBING 1730 a cable element group. TUBING 1730 cable element group includes 5/32″ OD Tubing, Polyurethane 1740, ¼″ OD Tubing, Polyurethane 1742, ⅜″ OD Tubing, Polyurethane 1744, 5/32″ OD Tubing, Teflon® 1750, ¼″ OD Tubing, Teflon® 1752, and ⅜″ OD Tubing, Teflon® 1754 of one embodiment.

### Modules and Jacket Elements Cable Element Groups:

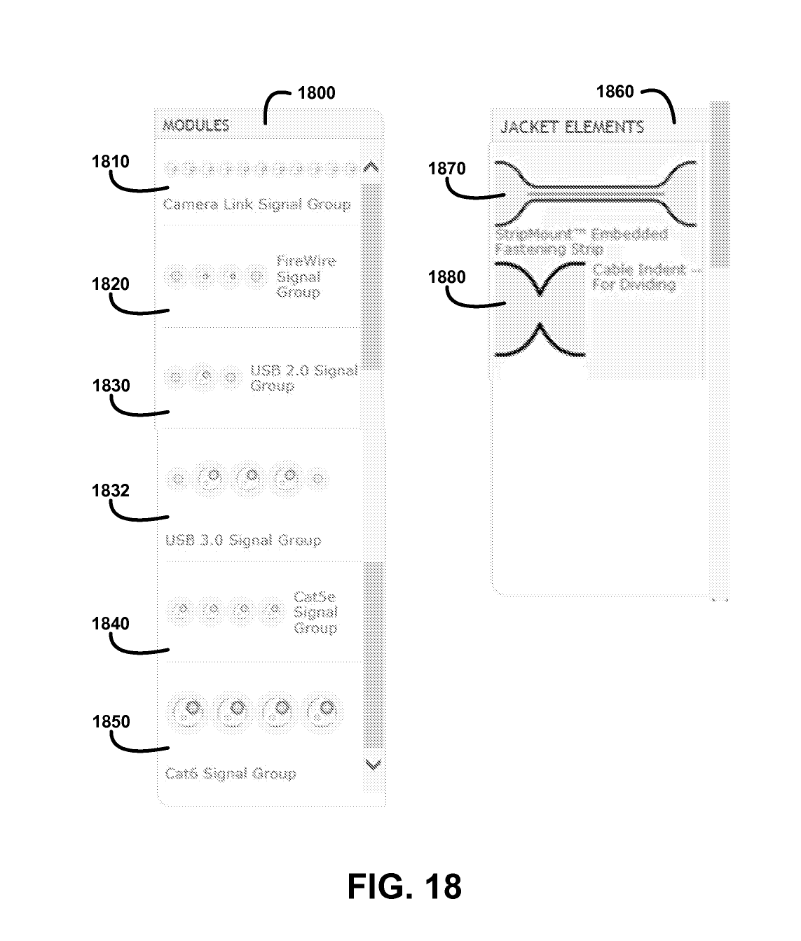

FIG. 18 shows for illustrative purposes only an example of modules and jacket elements cable element groups of one embodiment. FIG. 18 shows an example of MODULES 1800 a cable element group. The MODULES 1800 cable element group includes Camera Link Signal Group 1810, FireWire Signal Group 1820, USB 2.0 Signal Group 1830, USB 3.0 Signal Group 1832, Cat5e Signal Group 1840 and Cat6 Signal Group 1850. FIG. 18 shows an example of JACKET ELEMENTS 1860 a cable element group. The JACKET ELEMENTS 1860

cable element group includes StripMount™ Embedded Fastening Strip 1870 and Cable Indent—For Dividing 1880 of one embodiment.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. An apparatus, comprising:
an automated custom flat cable configurator program to allow a user to design a custom flat cable using cable elements;
at least one drag and drop flat cable element, wherein a user selects at least one cable element;
an automated digital code program to automatically create a concurrent cable assembly drawing, a listing of selected cable elements, and calculate a cable life and a cable price from user drag and drop selected cable elements; and
an automated user interface wherein the user submits a final custom flat cable configurator program cable assembly and the user is sent automatically an email with a final cable assembly drawing, a no-obligation price, a final listing of selected cable elements, and final custom flat cable purchase instructions.

2. The apparatus of claim 1, wherein the at least one drag and drop flat cable element is configured to include at least one element group, at least one element description, at least one element drawing symbol and an EZ-strip flat cable element.

3. The apparatus of claim 1, wherein the digital code program is configured for automated calculation of a thickness of cable insulation, conduit/tubing spacing, cable assembly dimensions, cable life and a purchase price for the user selected custom cable.

4. The apparatus of claim 1, wherein the automated user interface is configured to include an internet connection accessible using digital electronic devices including computers.

5. The apparatus of claim 1, wherein the automated user interface is configured to include a wireless internet connection accessible using digital electronic devices including mobile devices including a laptop, tablet, and smart phones with a custom flat cable configurator program application installed.

6. The apparatus of claim 1, wherein the at least one drag and drop flat cable element configured to include power cable elements including 24 AWG, Single, Shielded; 24 AWG, Twisted Pair, Shielded; 22 AWG, Single, Unshielded; 22 AWG, Single, Shielded; 22 AWG, Twisted Pair, Unshielded; 22 AWG, Twisted Pair, Shielded; 20 AWG, Single, Shielded; 18 AWG, Single, Unshielded; 18 AWG, Single, Shielded; 18 AWG, Twisted Pair, Shielded; 16 AWG, Single, Shielded; 14 AWG, Single, Shielded; 12 AWG, Single, Shielded; and 10 AWG, Single, Shielded.

7. The apparatus of claim 1, wherein the at least one drag and drop flat cable element signal cable elements including 30 AWG, 100 Ohm Twinax; 28 AWG, Single, Unshielded; 28 AWG, Single, Shielded; 28 AWG, Twisted Pair, Unshielded; 28 AWG, Twisted Pair, Shielded; 28 AWG, 100 Ohm, Twinax; 28 AWG, Type J, Thermocouple; 28 AWG, Type K, Thermocouple; 28 AWG, 5 Twisted Pairs, Shielded; 26 AWG, Single, Shielded; 26 AWG, Twisted Pair, Shielded; 26 AWG, Twisted Tri, Shielded; and 24 AWG, 100 Ohm, Twinax.

8. The apparatus of claim 1, wherein the at least one drag and drop flat cable element video cable elements including 30 AWG, 75 Ohm, Coax; 30 AWG, 50 Ohm, Coax; and 100 Ohm Twinax (Camera Link).

9. The apparatus of claim 1, wherein the at least one drag and drop flat cable element tubing cable elements including 5/32″ OD Tubing, Polyurethane; ¼″ OD Tubing, Polyurethane; ⅜″ OD Tubing, Polyurethane; 5/32″ OD Tubing, Teflon®; ¼″ OD Tubing, Teflon® and ⅜″ OD Tubing, Teflon®.

10. The apparatus of claim 1, wherein the at least one drag and drop flat cable element modules cable elements including Camera Link Signal Group; FireWire Signal Group; USB 2.0 Signal Group; USB 3.0 Signal Group; Cat5e Signal Group; Cat6 Signal Group and jacket elements cable elements including StripMount™ Embedded Fastening Strip; and Cable Indent For Dividing.

11. A method, comprising:
recording and retrieving cable elements in an automated digital database;
using an automated digital interface configured for allowing a user to select cable elements to design a custom flat cable; and
integrating an automated digital code between the automated digital database and the automated digital interface to configure and display a user created custom cable and edit the same,
wherein the automated digital code is configured to include calculating user selected custom cable features.

12. The method of claim 11, wherein recording and retrieving cable elements includes at least one element group, at least one element description, at least one element drawing symbol and an EZ-strip flat cable element.

13. The method of claim 11, wherein using an automated digital interface includes a user selecting, editing and configuring cable elements using an internet connection including a wireless internet connections and interfacing using digital electronic devices including computers and mobile devices.

14. The method of claim 11, wherein using an automated digital interface access custom flat cable configurator program application installed on mobile devices including a laptop, tablet, smart phones.

15. The method of claim 11, wherein using the automated digital code includes automatically calculating a thickness of cable insulation, conduit/tubing spacing, cable assembly dimensions, cable life and a purchase price for the user selected custom cable.

16. An apparatus, comprising:
an automated digital database for recording and retrieving elements;
an automated digital interface configured for allowing a user to select and configure elements recorded in the automated digital database using digital electronic devices; and
an automated digital code configured for designing a custom device using user selected elements.

17. The apparatus of claim 16, wherein the automated digital database is configured to include at least one element group, at least one element description, at least one element drawing symbol and an EZ-strip flat cable element.

18. The apparatus of claim 16, wherein the automated digital interface is configured to include an internet connection accessible using digital electronic devices including computers.

19. The apparatus of claim 16, wherein the automated digital interface is configured to include a wireless internet connection accessible using digital electronic devices including mobile devices including a laptop, tablet, smart phones with a custom flat cable configurator program application installed.

20. The apparatus of claim 16, wherein the automated digital code is configured for automatically calculating a thickness of cable insulation, conduit/tubing spacing, cable assembly dimensions, cable life and a purchase price for the user selected custom cable.
